(19) United States
(12) Patent Application Publication
(10) Pub. No.: US 2025/0363590 A1
(43) Pub. Date: Nov. 27, 2025

(54) Recursively-Cascading Diffusion Model for Image Interpolation

(71) Applicant: Google LLC, Mountain View, CA (US)

(72) Inventors: Deqing Sun, Boston, MA (US); Junhwa Hur, Cambridge, MA (US); Charles Irwin Herrmann, Boston, MA (US); Saurabh Saxena, Mississauga (CA); David James Fleet, Toronto (CA); Janne Matias Kontkanen, San Francisco, CA (US); Wei-Sheng Lai, San Mateo, CA (US); Yichang Shih, Cupertino, CA (US); Michael Rubinstein, Natick, MA (US)

(21) Appl. No.: 19/216,388

(22) Filed: May 22, 2025

Related U.S. Application Data
(60) Provisional application No. 63/650,813, filed on May 22, 2024.

(51) Int. Cl. G06T 3/4007; G06T 3/4076; G06T 5/60; G06T 5/70

(52) U.S. Cl. CPC G06T 3/4007; G06T 3/4076; G06T 5/60; G06T 5/70; G06T 2207/20081

(57) ABSTRACT

Despite recent progress, existing frame interpolation methods still struggle with extremely high resolution images and challenging cases such as repetitive textures, thin objects, and fast motion. To address these issues, provided is a cascaded diffusion frame interpolation approach that excels in these scenarios while achieving competitive performance on standard benchmarks.

### PRIORITY CLAIM

The present application is based on and claims priority to U.S. Provisional Application 63/650,813 having a filing date of May 22, 2024, which is hereby incorporated by reference in its entirety.

### FIELD

The present disclosure relates generally to machine learning models. More particularly, the present disclosure relates to the training and use of a recursively-cascading diffusion model for image interpolation.

### BACKGROUND

Image interpolation is a computational technique used to estimate and generate one or more intermediate images between two or more image frames. Image interpolation can be performed to enhance the resolution or frame rate of visual media such as videos.

Existing image interpolation techniques struggle when applied to high-resolution images and complex motion scenarios. In particular, traditional methods typically rely on motion-based approaches, where frames are interpolated by estimating bi-directional optical flow between consecutive frames. These methods then synthesize an intermediate frame through techniques such as forward splatting or backward warping. However, the accuracy of these methods heavily depends on the precision of the estimated motion fields. Inaccuracies in motion estimation can lead to artifacts, particularly in scenarios involving large motion, occlusions, or detailed textures, thus degrading the visual quality of the interpolated frames.

Kernel-based approaches, which estimate per-pixel kernels to synthesize intermediate frames, attempt to address some of these challenges by reducing reliance on motion estimators. Despite this, they often struggle to maintain performance on high-resolution datasets or in the presence of complex motion due to limitations in handling dynamic changes across frames. Similarly, phase-based methods, which represent frames in a phase-based domain to estimate intermediates, also falter with large motion, as they cannot adequately capture the extensive range of motion dynamics.

Furthermore, many existing methods incorporate hand-crafted features and domain-specific knowledge, which can restrict the adaptability and generalization of the interpolation models to varied content and scenarios. This reliance on predefined structures and assumptions limits the flexibility and scalability of frame interpolation techniques, particularly when faced with the diverse and challenging conditions present in real-world video data.

### SUMMARY

Aspects and advantages of embodiments of the present disclosure will be set forth in part in the following description, or can be learned from the description, or can be learned through practice of the embodiments.

One general aspect includes obtaining recursively for each of one or more patch-based frame interpolation stages: generating, by the computing system, a plurality of groups of patches, where each group of patches may include a respective patch from each of: a current version of the first input frame, a current version of the second input frame, and an input version of a predicted intermediate frame associated with an intermediate time that is temporally between the first time and the second time, and where each patch has a second resolution that is smaller than the input resolution; and respectively processing, by the computing system, the plurality of groups of patches and a respective noisy input with a machine-learned diffusion model to generate a respective predicted patch for a denoised version of the predicted intermediate frame; and accumulating, by the computing system, the respective predicted patches to generate the denoised version of the predicted intermediate frame. Other embodiments of this aspect include corresponding computer systems, apparatus, and computer programs recorded on one or more computer storage devices, each configured to perform the actions of the methods.

Implementations may include one or more of the following features. The computer-implemented method where the one or more patch-based frame interpolation stages may include a plurality of patch-based frame interpolation stages. For each of the plurality of patch-based frame interpolation stages, the patches have a may include resolution and the same machine-learned diffusion model is used. For each of the plurality of patch-based frame interpolation stages except a final stage, the method further may include upsampling the denoised version of the predicted intermediate frame to generate the input version of the predicted intermediate frame for a next stage. For each of the plurality of patch-based frame interpolation stages, the current version of the first input frame and the current version of the second input frame have been downsampled to a current resolution respectively associated with the stage. For a final stage of the plurality of patch-based frame interpolation stages, the method further may include outputting, by the computing system, the denoised version of the predicted intermediate frame as an output. The first downsampled input frame and the second downsampled input frame have the second resolution; and processing, by the computing system, a noisy input with a machine-learned denoising diffusion model that is conditioned on the first downsampled input frame and the second downsampled input frame to generate an initial version of the predicted intermediate frame, where the initial version of the predicted intermediate frame has the second resolution. The computer-implemented method may include, prior to the one or more patch-based frame interpolation stages constructing an n-level image pyramid from the first input frame and the second input frame. The groups of patches may include groups of overlapping patches. The machine-learned diffusion model may include a pixel diffusion model. Implementations of the described techniques may include hardware, a method or process, or computer software on a computer-accessible medium.

One general aspect includes a computing system configured to train a denoising diffusion model. The computing system also includes obtaining, by a computing system may include one or more computing devices, a first input frame associated with a first time, a second input frame associated with a second time that is subsequent to the first time, and a target version of an intermediate frame that is associated with an intermediate time that is temporally between the first time and the second time; generating, by the computing system, a noisy version of the intermediate frame; generating, by the computing system, a plurality of groups of patches, where each group of patches may include a respective patch from each of: first input frame, the second input frame, and the noisy version of the intermediate frame; respectively processing, by the computing system, the plurality of groups of patches and a respective noisy input with the denoising diffusion model to generate a respective predicted patch for a denoised version of the intermediate frame; and modifying, by the computing system, one or more values of one or more parameters of the denoising diffusion model based on a loss function that compares the denoised version of the intermediate frame with the target version of the intermediate frame. Other embodiments of this aspect include corresponding computer systems, apparatus, and computer programs recorded on one or more computer storage devices, each configured to perform the actions of the methods.

Implementations may include one or more of the following features. The computing system where generating, by the computing system, the noisy version of the intermediate frame may include: generating, by the computing system, a lower resolution version of the intermediate frame; and upsampling, by the computing system, the lower resolution version of the intermediate frame to obtain the noisy version of the intermediate frame. Generating, by the computing system, the lower resolution version of the intermediate frame may include: respectively downsampling, by the computing system, the first input frame and the second input frame to respectively generate a first downsampled input frame and a second downsampled input frame; and processing, by the computing system, the first downsampled input frame and the second downsampled input frame with a base diffusion model to generate the lower resolution version of the intermediate frame. Implementations of the described techniques may include hardware, a method or process, or computer software on a computer-accessible medium.

One example aspect of the present disclosure is directed to a computing system to perform image interpolation with improved computational efficiency. The computing system includes one or more processors and one or more non-transitory computer-readable media that collectively store instructions that, when executed by the one or more processors, cause the computing system to perform operations. The operations include obtaining a first input image associated with a first time and a second input image associated with a second time that is subsequent to the first time, wherein the first input image and the second input image have a first image resolution. The operations include downsampling the first input image and the second input image to generate a first downsampled input image and a second downsampled input image, wherein the first downsampled input image and the second downsampled input image have a second image resolution that is less than the first image resolution. The operations include processing the first downsampled input image, the second downsampled input image, and a first noisy input with a recursively-cascading machine-learned denoising diffusion model to generate a first predicted image, wherein the first predicted image is associated with a third time that is temporally between the first time and the second time, and wherein the first predicted image has the second image resolution. The operations include upsampling the first predicted image to generate a first upsampled predicted image that has the first resolution. The operations include processing at least the first upsampled predicted image and a second noisy input with the recursively-cascading machine-learned denoising diffusion model to generate a second predicted image, wherein the second predicted image is associated with the third time that is temporally between the first time and the second time, and wherein the second predicted image has the first image resolution.

In some implementations, the recursively-cascading machine-learned denoising diffusion model has been trained on one or more image quadruplets, each image quadruplet comprising a first training image, a second training image, a target intermediate image, and a first upsampled predicted image, the first upsampled predicted image being an upsampled version of a first predicted image predicted at a lower resolution. In some implementations, during the training of the recursively-cascading machine-learned denoising diffusion model, dropout was performed on the first upsampled predicted image. In some implementations, the recursively-cascading machine-learned denoising diffusion model performs eight or fewer denoising steps. In some implementations, the recursively-cascading machine-learned denoising diffusion model performs four or fewer denoising steps. In some implementations, processing at least the first upsampled predicted image and the second noisy input with the recursively-cascading machine-learned denoising diffusion model to generate the second predicted image comprises processing the first upsampled predicted image, the first input image, the second input image, and the second noisy input with the recursively-cascading machine-learned denoising diffusion model to generate the second predicted image.

Another example aspect of the present disclosure is directed to a computer-implemented method to generate a recursively-cascading diffusion model. The method includes training, by a computing system comprising one or more computing devices, a base denoising diffusion model on one or more image triplets, each image triplet comprising a first input image associated with a first time, a second input image associated with a second time that is subsequent to the first time, and a target intermediate image associated with a third time that is temporally between the first time and the second time, wherein training the base denoising diffusion model on the image triplets comprises training the base denoising diffusion model to predict the target intermediate image from a first noisy input conditioned on the first input image and the second input image. The method includes training, by the computing system, the recursively-cascading diffusion model on one or more image quadruplets, each image quadruplet comprising the first input image, the second input image, the target intermediate image, and a first upsampled predicted image, the first upsampled predicted image being an upsampled version of a first predicted image generated by the base denoising diffusion model, wherein training the recursively-cascading diffusion model comprises training the recursively-cascading diffusion model to predict the target intermediate image from a second noisy input conditioned on the first input image, the second input image, and the first upsampled predicted image. The method includes providing, by the computing system, the recursively-cascading diffusion model as an output.

In some implementations, the method further includes performing inference using the recursively-cascading diffusion model, wherein performing inference using the recursively-cascading diffusion model comprises recursively generating a plurality of predicted images with the recursively-cascading diffusion model over a plurality of different image scales. In some implementations, the method further includes initializing, by the computing system, the recursively-cascading diffusion model from the base denoising diffusion model. In some implementations, training, by the computing system, the recursively-cascading diffusion model on the one or more image quadruplets comprises, for at least one training iteration, performing dropout on the first upsampled predicted image.

Another aspect of the present disclosure is directed to one or more non-transitory computer-readable media that collectively store instructions that, when executed by a computing system, cause the computing system to perform operations. The operations are performed for each of a plurality of recursions respectively associated with a plurality of different image scales. The operations include: obtaining a pair of input images associated with the image scale; upsampling a smaller-resolution predicted image generated by a recursively-cascading machine-learned denoising diffusion model for a smaller image scale to obtain an upsampled version of the smaller-resolution predicted image; and processing the pair of input images, the upsampled predicted image, and a noisy input with the recursively-cascading machine-learned denoising diffusion model to generate a predicted image for the image scale.

In some implementations, the recursively-cascading machine-learned denoising diffusion model has been trained on one or more image quadruplets, each image quadruplet comprising a first training image, a second training image, a target intermediate image, and a first upsampled predicted image, the first upsampled predicted image being an upsampled version of a first predicted image predicted at a lower resolution. In some implementations, during the training of the recursively-cascading machine-learned denoising diffusion model, dropout was performed on the first upsampled predicted image. In some implementations, the recursively-cascading machine-learned denoising diffusion model performs eight or fewer denoising steps. In some implementations, the recursively-cascading machine-learned denoising diffusion model performs four or fewer denoising steps.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example base model according to example embodiments of the present disclosure.

FIG. 2 depicts a block diagram of an example patch-based cascade model according to example embodiments of the present disclosure.

FIG. 3 depicts a block diagram of an example upsampling strategy according to example embodiments of the present disclosure.

FIG. 4A depicts a block diagram of an example computing system that performs image interpolation according to example embodiments of the present disclosure.

FIG. 4B depicts a block diagram of an example computing device that performs image interpolation according to example embodiments of the present disclosure.

FIG. 4C depicts a block diagram of an example computing device that performs image interpolation according to example embodiments of the present disclosure.

Reference numerals that are repeated across plural figures are intended to identify the same features in various implementations.

### DETAILED DESCRIPTION

### Example Patch-Based Approaches

Example aspects of the present disclosure are directed to patch-based cascaded diffusion techniques which can be used, for example, to interpolate a frame at an intermediate time between two known frames. This approach addresses challenges encountered by prior methods when processing difficult visual elements, for example repetitive textures and large motions, at high resolutions.

In some implementations, the system can split frames into smaller patches and denoise them at a consistent, lower-resolution scale. This patch-based design can reduce inference-time memory usage. For instance, the system can create overlapping patches from the two input frames, as well as a partial prediction of the intermediate frame, and then employ a diffusion model to generate denoised patches that are merged back to form a full-resolution output.

For example, in some implementations, a low-resolution intermediate result can be generated, upsampled, and combined with two input frames to form overlapping patches. Each patch can then be denoised individually, and denoised patches can be merged into a coherent full-size image. In some implementations, this process can begin at a coarse scale and proceed to progressively finer scales by upsampling and denoising. The same architecture can be applied throughout all upsample layers without requiring separate models.

In some implementations, the patch-based cascade can follow a coarse-to-fine strategy that constructs an N-level pyramid. At the lowest scale, downsampled input frames can be used to generate an initial intermediate prediction. The system can then iteratively refine that prediction at higher scales through bilinear upsampling, patch extraction, denoising, and patch merging. This approach may reduce memory load at each step while preserving localized details.

In some implementations, the same diffusion model can be reused across multiple scales. For instance, the method can begin by generating a coarse version of the intermediate frame and then progressively upsample and refine the prediction through repeated patch-based denoising stages. This single-model approach may improve overall efficiency because it avoids training, storing, and/or serving a separate model for each scale.

Another aspect provided herein is a training scheme in which low-resolution estimates of the intermediate frame are upsampled and treated as noisy inputs. Through a loss function on the denoised predictions, the diffusion model can learn to refer to both the coarse intermediate estimate and the original input frames for fine details. This design addresses limitations in older approaches, such as flow-based methods, that often produce artifacts when large motion or thin objects are present.

Thus, the present disclosure describes a flexible technique for high-resolution frame interpolation that can handle demanding scenes. By splitting frames into patches, reusing a single diffusion model, and training on a coarse-to-fine basis, it may alleviate problems of memory consumption and visual inconsistencies, especially when dealing with large motions and detailed textures.

More particularly, in some implementations, a computing system can retrieve a first input frame at a first time and a second input frame at a subsequent time, both at a designated input resolution. For example, the system can receive video frames from a camera stream where each frame is captured in a defined image size. In some implementations, these frames can be stored in memory or accessed through a networked data source to facilitate further processing steps.

In some implementations, a recursive cascade of patch-based interpolation stages can be applied, where each stage refines the intermediate frame prediction before proceeding to the next. For example, the computing system can process frames in a multi-stage loop, gradually accounting for additional context or resolution at each iteration. This approach may improve the overall result by combining information generated at each layer of the cascade without interrupting later stages.

Each stage in the recursive cascade of stages can include a number of operations. In some implementations, at each stage, the system can generate multiple groups of reduced-resolution patches, each group including one patch from the current version of the first input frame, one patch from the current version of the second input frame, and one patch representing a portion of a predicted intermediate frame. For example, the method can collect overlapping patches from each frame so localized details are captured in distinct segments. This grouping of patches at a smaller resolution may help reduce memory usage while preparing detailed content for further refinements.

In some implementations, at each stage, the system can pass each group of patches, along with a corresponding noisy input, to a diffusion model that has been trained to denoise image data. For example, this machine-learned model can refine local structures in each patch by progressively reducing noise and matching the underlying content. By generating a predicted patch for the intermediate frame at each step, the system may attain more accurate reconstruction of fine details across the final denoised outcome.

In some implementations, at each stage, the system can combine the predicted patches at their respective positions to assemble a coherent version of the intermediate frame. For example, overlapping patches can be blended using weighting factors to reduce any seam lines and produce a smooth composite result. By merging all predicted patches into a single output, the system may preserve details while ensuring visual consistency across the denoised frame.

Thus, in some implementations, the system can include multiple patch-based stages that operate in a consecutive manner to refine the intermediate frame prediction. For instance, each stage can rely on the result of its predecessor and progressively update the patches with denoised content. This layered strategy may allow the system to capture additional spatial details over several iterations, helping to produce a more coherent final frame.

In some implementations, each interpolation stage can rely on patches of the same resolution while employing a shared machine-learned diffusion model. For example, the system can define a fixed patch size and pass this standardized input structure into a single model repeatedly, facilitating consistent training and deployment. This approach may reduce overhead because it avoids training, maintaining, and/or serving multiple different specialized models for different stages.

In some implementations, the computing system can upsample each refined intermediate frame to serve as input for a subsequent stage, with the exception of the last stage that provides the final output. For example, after generating a denoised version of the intermediate frame at one stage, the system can rescale that result before passing it on. This incremental enlargement may allow the system to progressively incorporate more detail while preserving the improvements made at earlier stages.

In some implementations, the system can operate on downsampled versions of the first and second frames at each stage. For example, if the overall interpolation process has multiple stages, the original frames can be resized to a lower resolution before patch extraction and denoising. This staged downsampling may help manage memory usage more efficiently while retaining enough information to guide reconstruction of the missing frame content at subsequent stages.

In particular, in some implementations, the system can downsample each input frame to a smaller resolution before producing an initial intermediate frame. For example, the system can shrink both the first and second frames and apply a diffusion model that combines these reduced inputs with a noisy version of the intermediate frame. This approach may facilitate a more efficient starting point for subsequent patch-based interpolation stages, since the model initializes the intermediate frame at the same compact scale.

In some implementations, the system can generate a multi-scale representation of the two input frames by constructing an N-level image pyramid prior to the patch-based interpolation process. For example, the system can repeatedly downsample the frames to produce several levels of progressively lower resolutions, each capturing different spatial details. This pyramid may facilitate more efficient processing at each scale, since interpolation stages can leverage increasingly refined versions of the frames.

In some implementations, upon completing the last iteration of patch-based refinements, the system can provide the fully denoised intermediate frame as an output. For example, the method can store or transmit this final result for subsequent use, such as playback or further processing. This final output may combine all improvements introduced in earlier stages, thereby allowing a consistent and refined frame to be accessed as needed.

In some implementations, the patches within each group can overlap so that adjacent patches share a region of pixels. For example, the system can select overlapping patches to minimize abrupt boundaries when these patches are reassembled. This overlapping approach may help blend features between patches, improving overall frame consistency in the visual output.

In some implementations, the approach can include a pixel diffusion model that directly processes image pixels during each denoising iteration. This strategy may preserve local structures in a detailed manner, because it addresses every pixel value individually.

Another aspect is directed to approaches to train a denoising diffusion model for frame interpolation. In some implementations, a training system can gather a first input frame, a second input frame, and a known target version of the intermediate frame, each corresponding to respective time. For example, the system can retrieve these frames from a video sequence and choose one as the target output for the intermediate time.

In some implementations, the system can create a modified, noisy copy of this target by injecting random disturbances or other noise patterns. By having the noisy and the original versions of the intermediate frame, the system may set up a training scenario where the model learns to differentiate and eliminate noise through iterative refinement.

In some implementations, the system can organize multiple sets of patches by extracting a patch from each of the first input frame, the second input frame, and a noisy version of the intermediate frame. For example, these grouped patches can represent small regions of each image that capture local details like edges or thin structures. The system can then pass the patch groups, along with a respective noisy input, into the denoising diffusion model to generate refined patches for the intermediate frame. This process may reduce noise more precisely by isolating each region and correcting it in reference to the inputs.

In some implementations, the system can update the diffusion model's parameters by measuring the difference between the denoised intermediate frame and the target frame. For example, the system can compute a loss function based on pixel-level discrepancies and then apply a gradient-based operation to reduce this difference. This approach may guide the model to produce intermediate frames that align more closely with the target version, leading to improved predictive accuracy over repeated training cycles.

In some implementations, the system can form the noisy version of the intermediate frame by first generating a low-resolution representation of that frame and then scaling it back to a higher resolution. For example, the system can take a compressed, downsampled image of the intermediate frame and employ an upsampling procedure that naturally introduces variations or artificial distortions. This two-step process may provide training data where the denoising diffusion model refines the upsampled content back into a cleaner, more accurate version of the intermediate frame.

In some implementations, the system can downsample both input frames and then employ a base diffusion model on these reduced representations to produce a lower resolution intermediate frame. For example, the system can shrink the first and second frames via a standard re-sampling routine, feeding these downsampled versions into the base diffusion model. By relying on this base model to achieve an initial intermediate frame at limited resolution, the process may reduce memory cost and simplify training before further refinement steps.

Example technical problems resolved by the present disclosure relate to the usage of computing resources when performing high-resolution frame interpolation. Specifically, high-resolution video frame interpolation often involves large data sizes and complex image structures that demand significant computing resources. Handling complexity at high resolutions can lead to prohibitive memory usage and slow processing times. For instance, frames containing large motion or thin objects may not be accurately interpolated by conventional approaches, resulting in visual artifacts or degradation in output quality. Additionally, repetitive textures and wide dynamic ranges can strain existing optical flow or warping algorithms, leading to poor scalability or inconsistent performance.

The described technology addresses the efficient handling of large image data, which is a technical consideration in modern computing systems. By reducing the dimensionality of data processed at once, the approach can lessen memory constraints, enabling higher-performance video interpolation on standard hardware. This alleviation of resource bottlenecks represents an advancement in computing resource management.

The architecture also improves the reliability of the interpolation process under demanding conditions, such as scenes featuring large motion or intricate details. By segmenting and refining localized regions, it offers a more robust way to process numerous input pixels without overwhelming computational capacity. This enhances the system's ability to deliver higher-fidelity results, signifying an improvement in how software algorithms interact with physical hardware resources. Furthermore, the patch-based approach can be efficiently and effectively parallelized, resulting in reduced latency and the ability to flexibly distribute compute requirements.

Moreover, the design of the model enables a more streamlined workflow by integrating multiple processing steps in a single iterative framework. This approach contributes to faster inference, which can be valuable in real-time applications like streaming or camera-based monitoring. Such optimization of computational workflow represents an advance in the manner a computing apparatus handles and processes frame interpolation tasks.

The proposed techniques can be applied to a number of different use cases or applications. As one example, many video editing scenarios can benefit from higher-quality frame interpolation. For example, in a film production workflow, an editor can supply two high-resolution frames from a scene shot at a low frame rate as the input. The proposed technique can then generate extra frames to form a smooth camera pan, leading to an output video that contains additional frames between the original captures. This approach may be particularly helpful when creating cinematic slow-motion effects for action sequences or dramatic transitions.

Another potential application involves video conferencing. In some implementations, a communication platform can apply the technique to fill gaps between frames when network congestion causes missing or delayed packets. For instance, given two partially corrupted frames and partial data from the sender, the system can predict frames that compensate for the lost information. The output is a clearer, more continuous video feed, improving the perceived quality of real-time remote interactions.

Virtual reality (VR) content generation can also benefit from this approach. For example, a VR system can take two wide-field captures of a rapidly changing scene as input. Using the proposed technique, the system can produce intermediate frames that help reduce motion artifacts and flicker, resulting in smoother head-tracked experiences. The final output is a sequence of frames with fewer disruptive jumps, enhancing user comfort during immersive sessions.

In fields like medical imaging, intermediate frame creation can also be valuable. For instance, an ultrasound machine capturing a patient's heartbeat at specific intervals can use two reference frames and generate an in-between rendering to visualize subtle heart wall movements. The result may be a set of interpolated frames offering additional insight into cardiac function, supporting physicians in diagnosis or surgical planning.

### Example Approaches for Recursively-Cascading Machine-Learned Denoising Diffusion Model

Additional aspects of the present disclosure are directed to systems and methods that leverage a recursively-cascading machine-learned denoising diffusion model to generate one or more intermediate frames between two input image frames, such as, for example, consecutive frames from a video. One aspect of the present disclosure is directed to the recursive use of a single, shared denoising diffusion model across different cascading stages respectively associated with different image scales or resolutions. This approach contrasts with traditional methods where separate models are trained for different resolution scales. By using a single model, the disclosed method can reduce both the computational overhead and the memory footprint, making it more efficient for deployment in devices with limited resources. The proposed techniques are particularly advantageous in scenarios involving high-resolution images and/or complex motion patterns and can significantly enhance the temporal resolution of videos without compromising spatial quality.

More particularly, an example training process for training the recursively-cascading diffusion model can include a structured, multi-stage approach. Initially, a base denoising diffusion model can be trained using a set of image triplets, where each triplet includes two input images captured at sequential times and a target intermediate image that represents the “ground truth” frame between these times. The base model learns to predict the target intermediate frame from a noisy input conditioned on the two input images.

Subsequently, the recursively-cascading diffusion model can be trained using image quadruplets. Each quadruplet can include the original input images, the target intermediate image, and an upsampled version of a predicted image produced by the base model. This training phase trains the cascading model to predict the target intermediate image conditioned on the original inputs and the upsampled prediction from the base model.

Then, the fully trained recursively-cascading model can be provided as an output by the computing system, ready for deployment in applications requiring efficient and accurate frame interpolation. For example, the trained recursively-cascading model can be stored, transmitted, incorporated into a deployment pipeline, etc.

At inference time, the recursively-cascading diffusion model can be deployed in a series of generative recursions that operate across multiple image scales. This multi-scale approach can operate to progressively enhance the resolution and detail of the interpolated frames. For example, initially, for each recursion corresponding to a specific image scale, the system begins by obtaining a pair of input images that are sized at the current scale. These images represent frames captured at consecutive times, and their resolution matches the scale at which the model is currently operating.

A next step includes upsampling a previously-generated lower-resolution predicted image. This image, produced by the recursively-cascading model at a smaller scale in a prior recursion, is upscaled to match the current scale's resolution. The upsampling process bridges the resolution gap between successive recursions, allowing the model to refine details progressively as it moves to higher resolutions. At the first recursion, a blank or null image can be used as there is no lower-resolution predicted image.

After obtaining the upscaled version of the lower-resolution predicted image, the system then processes this image along with the pair of input images and a noisy input with the recursively-cascading diffusion model. At this processing step, the recursively-cascading diffusion model combines the information from the upscaled image and the original high-resolution inputs to generate a new predicted intermediate image at the current scale.

This predicted image, now enhanced in both detail and resolution, serves as the basis for the next recursion if further upscaling is desired. Thus, each recursion refines the image further, adjusting details and enhancing quality, ensuring that the final output closely approximates the desired intermediate frame with high fidelity. This iterative process continues until the highest required resolution is reached, at which point the final predicted image is outputted, representing the interpolated frame at full resolution.

Thus, the disclosed technology employs a cascading approach to manage the interpolation task across different resolutions. Initially, input frames can be downsampled to obtain downsampled inputs for each (smaller) image scale). At the smallest image scale, the inputs can be processed to predict a lowest-resolution intermediate frame. Then, the process described above can be performed for each of a number of increasing image scales to progressively upsample and refine the predicted intermediate images through any number of cascading stages. This method allows for handling details at multiple scales, which generates high-quality outputs in high-resolution settings.

According to another aspect of the present disclosure, in some implementations, the computing system can perform a dropout mechanism during the training of the cascade model. This mechanism can include occasionally (e.g., randomly) dropping out (e.g., rendering null or setting to zero) the lower resolution intermediate image during training. This forces the recursively cascading diffusion model to rely more on the high-resolution input frames as conditioning inputs. This strategy prevents the model from taking shortcuts that could compromise the quality of the interpolated frames, especially in terms of capturing fine details.

According to another aspect of the present disclosure, in some implementations, data augmentation techniques are employed to enhance the robustness and generalization of the model. These augmentations can be applied to all of the images contained in each training example, for example whether they are part of a triplet or a quadruplet. Augmentation techniques can include random cropping, which simulates different viewing angles and frame compositions, and horizontal or vertical flips, which help the model learn to handle mirror variations of motion and texture. As another example, temporal flipping can be performed to ensure the model is not biased towards the direction of time, making it adept at predicting frames regardless of the chronological order of the input frames. By applying these augmentation techniques uniformly across all images in a training set, the model gains a more comprehensive understanding of the variability in video data, leading to improved performance in diverse real-world scenarios.

Furthermore, while the techniques outlined in the present disclosure are primarily described in the context of a pixel diffusion model, they are equally applicable to a latent diffusion model. Latent diffusion models operate on a compressed, latent representation of the data, which can offer computational efficiencies and potentially faster processing times. The training methodologies, including the use of image triplets and quadruplets, as well as the recursively-cascading architecture and data augmentation strategies, can be adapted to work with latent diffusion models.

The systems and methods described in this section provide a number of technical effects and benefits. As one example, the recursively-cascading diffusion model introduced in the present disclosure significantly enhances performance in handling large motion and repetitive patterns. Traditional frame interpolation techniques often struggle with these complex scenarios due to limitations in motion estimation accuracy and the inability to handle repetitive textures without introducing artifacts. The proposed model leverages a cascading approach that refines predictions through multiple scales, allowing it to effectively capture and reconstruct the nuances of large and fast movements, as well as intricate patterns that recur within the frame.

As another example technical effect, the recursively-cascading diffusion model represents the consolidation of the functionality of multiple models into a single model and framework. This reduces the number of parameters that need to be stored, transmitted, and loaded during operation. In particular, unlike prior approaches where each cascade in a multi-cascade system is trained separately with its own distinct set of parameters, the proposed approach can integrate these cascades into one single model with a single set of parameters. This integration not only simplifies the model architecture but also enhances operational efficiency by minimizing the computational overhead associated with managing multiple models. As a result, the system demands less memory and bandwidth, which is particularly advantageous in environments with limited resources or where rapid processing is beneficial. This streamlined approach not only accelerates the training and inference processes but also reduces the potential for errors that might arise from handling multiple disparate models, thereby improving the reliability and performance of frame interpolation tasks.

Aspects of the present disclosure also improve training efficiency. For example, by initiating the training process from a base model that has already been trained on image triplets, the system provides a robust starting point that encapsulates fundamental interpolation capabilities. This pre-trained base model serves as a foundational layer, capturing basic dynamics of frame interpolation. The pre-trained base model can simplify the subsequent training phase for the more complex recursively-cascading model. As a result, this approach avoids the complexities and resource demands associated with training two entirely separate models from scratch. The cascading model, therefore, benefits from an accelerated training process, reduced computational overhead, and a streamlined development cycle, making it a more efficient solution for handling high-resolution video frame interpolation in diverse and dynamic environments.

According to another aspect of the present disclosure, in an alternative training approach, the single, shared cascading diffusion model can be trained directly from scratch in an arrangement that mirrors the setup used during inference time. This approach can include training the model on a sequence of progressively scaled images, starting with the lowest resolution and moving towards the highest, just as it operates during inference. By training the model in this way, it learns to handle the recursive and scaling nature of the task intrinsically, which can potentially enhance the coherence and efficiency of the model when it is deployed.

Another significant technical effect and benefit of the proposed recursively-cascading diffusion model is its scalability in handling any number of image scales or recursions without requiring additional model training. This capability enables the model to be easily applied in various different settings that have varying resolutions. By utilizing a single model that applies across multiple scales, the system avoids the need for separate training sessions for each scale, which is often the case with traditional cascading models that require individual training for each resolution increment. Consequently, the proposed approach offers a more efficient interpolation process that is capable of adapting to different resolutions.

The proposed diffusion model can be used in a number of different applications across various fields. As one example, in the entertainment industry, particularly in film and television production, this model can be used to enhance the frame rate of footage without compromising the quality, providing smoother and more visually appealing sequences. In this example, the inputs could be the original low-frame-rate video files, and the outputs could be the same videos but with interpolated frames that increase the frame rate and fluidity. Another example application is in sports broadcasting, where the model can help generate ultra slow-motion replays from standard video footage. The inputs in this case could be the original broadcast video, and the outputs could be slowed-down versions that maintain high resolution and detail, offering viewers enhanced clarity for critical plays. As yet another example, in the field of video game development, the model can be used to improve the rendering of dynamic scenes, providing a more immersive gaming experience. The inputs could be the real-time game engine outputs, and the interpolated frames could serve as outputs, ensuring smoother transitions and animations within the game.

The recursively-cascading diffusion model can be implemented in various computing systems, including those embedded in smartphones or other video-capable devices. The model can be integrated into the device's existing imaging pipeline, where it can work in real-time to enhance the frame rate of videos captured by the device, providing users with smoother and more detailed video playback.

With reference now to the Figures, example embodiments of the present disclosure will be discussed in further detail.

### Example Diffusion Model Arrangements

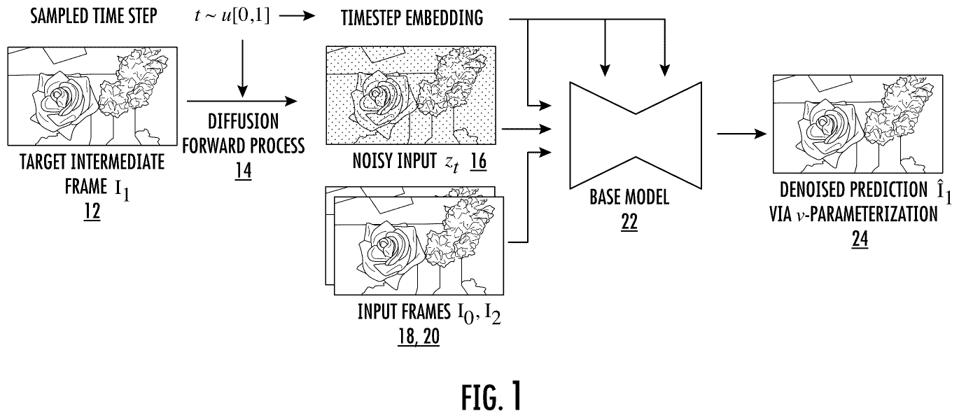

FIG. 1 depicts a block diagram of an example base model according to example embodiments of the present disclosure. The base model can be conditioned on two input frames, i0 and i2, and predicts an intermediate frame i1. The model can use v-parameterization for both model output and loss. For instance, the v-parameterization can be implemented by defining a vector v in a high-dimensional space that represents the transformation between the input frames and the intermediate frame. This vector can be computed using a series of convolutional and non-linear layers that analyze the differences and similarities between the input frames. To illustrate, the base model can include a series of residual blocks that refine the feature representation of the input frames, enhancing the model's ability to accurately predict the intermediate frame.

In particular, referring now to FIG. 1, target intermediate frame i1 12 can be an image region that represents an intermediate moment between two temporal frames, for example. Target intermediate frame i1 12 can be stored as a data structure in memory or on a storage device, and can be retrieved through a file access operation or a network call. For instance, the data structure could be a tensor in a GPU's memory that facilitates fast computation during the diffusion process. Additionally, the retrieval of this data structure can be optimized using caching mechanisms to reduce latency in real-time applications.

Diffusion forward process 14 can be a procedure that transforms or perturbs an image or pixel grid, for example. Diffusion forward process 14 can be carried out by software routines or by specialized hardware configured to apply random noise or related transformations. For instance, the diffusion forward process can include adding Gaussian noise to the input frames in a controlled manner, where the variance of the noise can be adjusted dynamically based on the training epoch or the specific requirements of the frame interpolation task.

Noisy input zt 16 can be a representation of an image or pixel array that has been modified to include random variations, for example. Noisy input zt 16 can be stored as an array of pixel intensities or any comparable data structure reflecting altered image content. For example, the noisy input can be generated by applying a noise model that considers the historical data of noise patterns in similar video sequences, thereby making the noise addition step more context-aware and effective in simulating real-world scenarios.

Input frame i0 18 can be an example of original image data collected at a certain time, for example. Input frame i0 18 can be downloaded from a remote database or generated by a camera sensor. In one embodiment, the input frame i0 can be pre-processed using techniques such as denoising, color correction, and geometric transformations to enhance the quality of the input data before it is fed into the base model.

Similarly, input frame i2 20 can be an example of subsequent or preceding image data representing a different time step, for example. Input frame i2 20 can also be obtained from a real-time video stream or from pre-recorded media. To illustrate, preprocessing steps similar to those applied to input frame i0 can be employed here to ensure consistency in data quality and characteristics between the two input frames.

Base model 22 can be a machine learning model, such as a diffusion model implemented using a neural network, that processes image data, for example. Base model 22 can be implemented with convolutional layers, attention mechanisms, or fully connected layers, depending on the chosen architecture. For instance, the convolutional layers can be specifically designed to capture spatial hierarchies in the image data, while attention mechanisms can be used to focus on areas with significant motion or changes between the frames, enhancing the model's predictive accuracy.

Denoised prediction i1 24 can be an output image derived by removing or reducing noise, for example. Denoised prediction i1 24 can be stored in a digital format and accessed for subsequent image-based operations. In one embodiment, the denoised prediction can be further refined using post-processing techniques such as sharpening, contrast adjustment, and color grading to enhance the visual quality of the interpolated frame, making it more similar to genuine frames captured by a camera.

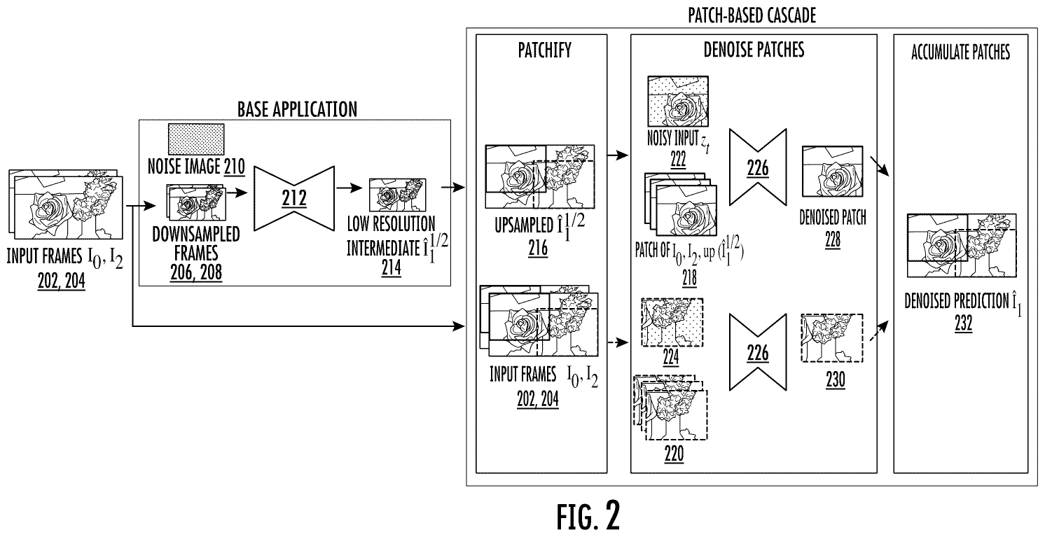

FIG. 2 depicts a block diagram of an example patch-based cascade model according to example embodiments of the present disclosure. Given a low-resolution intermediate from the previous level, the patch-based cascade can create patches from bi-linearly upsampled low-resolution intermediate and two input frames and uses these patches as conditioning for a diffusion process. It can then combine denoised patches to form the whole image. In some implementations, at inference time, only a single weight-shared model is recursively used across different image scales. A two-stage cascade is shown for simplicity, however, any number of stages can be used.

In some implementations, the patch-based cascade model can handle extremely high resolutions (up to 8K) by performing diffusion on patches of the input frames, keeping peak memory usage near constant at inference time. This allows the use of the same architecture for every upsample level and reuse of the same model for both base and super-resolution settings, saving training time and disk space.

In particular, referring now to FIG. 2, input frame i0 202 can be an example image taken at a particular time or from a particular source. Input frame i0 202 can be stored on a memory device or retrieved from a network-accessible location. Similarly, input frame i2 204 can be an example image corresponding to a different time or viewpoint. Input frame i2 204 can be captured sequentially after input frame i0 202, or can be obtained by other suitable capture arrangement. For instance, the input frames can be downsampled to a lower resolution for processing. For example, input conditioning images can be downsampled by a factor of (s_{N−1}) for processing at the lowest scale in the pyramid.

Downsampled frames 206, 208 can be an example of the input frames 202, 204 that have been resized to a smaller dimension. Downsampled frames 206, 208 can be generated by a software library configured to change resolution or by hardware specifically designed for image resizing. For instance, the downsampled frames serve as input to a base model 212, which computes a coarse solution at a lower resolution, and this solution is then used as a conditioning signal for further processing in the patch-based cascade model.

Noise image 210 can be an example of an image containing random or structured noise. Noise image 210 can be combined with other frames or remain separate, depending on how variations in pixel data might be introduced. For instance, during training, noise can be added to the conditioning frames to simulate different levels of image degradation, which the model learns to denoise, mimicking real-world scenarios where images may be subject to various types of noise.

Base model 212 can be an example of a computational model capable of processing image data. Base model 212 can be a diffusion model implemented as a trained neural network. For instance, the base model can be a U-Net architecture with self-attention layers, capable of handling the diffusion process where the noisy image is iteratively denoised to generate a clean intermediate frame.

Low resolution intermediate i1/2 214 can be an example of a partially refined image. Low resolution intermediate i1/2 214 can be stored in a common image format and can be read by software routines or hardware accelerators. For instance, this low-resolution intermediate represents a denoised output from the base model 212, which is then upsampled and used as part of the conditioning input for the next stage in the cascade.

Upsampled i1/2 216 can be an example of a resized version of low resolution intermediate i1/2 214. Upsampled i1/2 216 can be enlarged to a dimension closer to the original input resolution or to any other dimension that might be selected. For instance, upsampled i1/2 is used to create patches that are then processed by the patch-based cascade model to generate high-resolution outputs.

Patch of i0, i2, up(i1/2) 218 can be an example of a localized region taken from input frame i0 202, input frame i2 204, and upsampled i1/2 216. Patch of i0, i2, up(i1/2) 218 can be extracted as a relatively smaller array of pixel values. Similarly, patch of i0, i2, up(i1/2) 220 can be another example of a different localized region from input frame i0 202, input frame i2 204, and upsampled i1/2 216. Patch of i0, i2, up(i1/2) 220 can be selected at a different spatial location than patch of i0, i2, up(i1/2) 218. For instance, these patches are used as conditioning inputs for the diffusion model, which processes them to generate denoised patches as part of the high-resolution frame interpolation process.

Noisy input zt 222 can be an example of a data structure containing pixel values altered by noise or can be pure noise selected from a noise distribution (e.g., a Gaussian distribution). Noisy input zt 222 can be generated to depict random disturbances in the color or intensity channels. Noisy input zt 224 can be another example of a similarly perturbed or noisy data structure. For instance, these noisy inputs can be used in the training phase of the diffusion model to teach the model how to effectively denoise and reconstruct the original signal from corrupted inputs.

A diffusion model 226 can process the noisy input zt 222 and the patch of i0, i2, up(i1/2) 218 to generate a denoised patch 228. Similarly, the diffusion model 226 can process the noisy input 224 and the patch of i0, i2, up(i1/2) 220 to generate a denoised patch 230. For instance, the diffusion model 226 can implement a series of convolutional layers to process the input patches and noisy data, applying learned filters to reduce noise and enhance the quality of the patches.

Denoised patch 228 can be an example of an image region that has removed or reduced noise. Denoised patch 228 can be stored temporarily in memory or held in a cache as it proceeds to subsequent steps. Denoised patch 230 can be another example of an image region that has been subjected to noise reduction. Denoised patch 230 can differ from denoised patch 228 in terms of spatial position. For instance, these denoised patches are then merged to form a complete high-resolution frame, which represents the final output of the model, providing an interpolated frame that is inserted between the original input frames.

Denoised prediction i1 232 can be an example of a fully reconstructed frame after noise removal. Denoised prediction i1 232 can be retained in a file or utilized for subsequent image-based tasks. Denoised prediction i1 232 can be generated, for example, by accumulating denoised patches 228 and 230. One example approach that can be used for accumulation is the MultiDiffusion approach described in Bar-Tal et al. 2023. MultiDiffusion: Fusing diffusion paths for controlled image generation. In ICML.

For instance, this final denoised prediction can represent the high-resolution interpolated frame that is the output of the patch-based cascade model, providing enhanced video quality by interpolating additional frames into the video sequence. This process helps in achieving high-resolution video outputs that maintain visual quality even in scenarios with complex motion and textures.

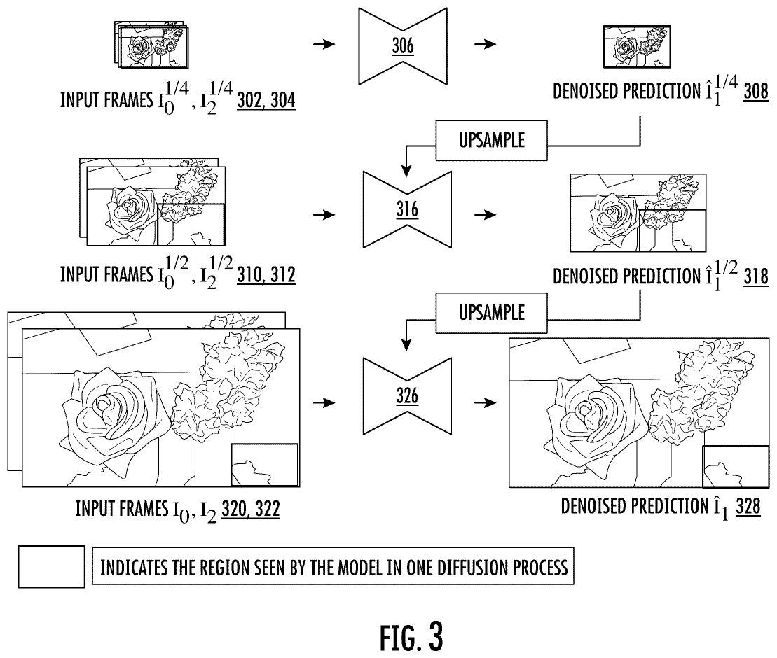

FIG. 3 depicts a block diagram of an example upsampling strategy according to example embodiments of the present disclosure. Example implementations can process the image from coarse to fine. Some example implementations always denoise at the same resolution, as indicated by the rectangular box. For instance, the upsampling strategy can include a patch-based cascade approach where diffusion is performed on patches of the input frames, maintaining peak memory usage nearly constant at inference time. This approach allows the same architecture to be used for every upsample level and reuses the same model for both base and super-resolution settings, saving training time and disk space. In one embodiment, the cascade can be implemented as an N-level image pyramid, where at each level, the process involves three stages: patchify, denoise patches, and accumulate patches.

In particular, referring to FIG. 3, Input frame i0\hat{ }1/4 302 can be an example of image data downsampled to one-quarter of an original resolution. Input frame i0\hat{ }1/4 302 can be generated by a software-based downsampling routine or any other suitable image resizing process. For instance, the downsampling can be performed using a bilinear interpolation method to reduce the resolution while preserving the essential features of the image. In one embodiment, the input frame can be pre-processed using a filtering technique such as Gaussian blur to smooth out noise before downsampling, which can help in maintaining the quality of the image data in subsequent processing stages.

Input frame i2\hat{ }1/4 304 can be another example of similarly downsampled image data, also at one-quarter resolution. Input frame i2\hat{ }1/4 304 can be stored in memory or provided by a sensor that captures image sequences. For instance, this frame can be part of a video sequence where each frame is sequentially downsampled and stored in a buffer for processing. In one embodiment, the frames can be downsampled in real-time using hardware-accelerated image processing techniques to ensure efficient handling of high-resolution video data.

Model 306 can be an example of a diffusion model. Model 306 can be constructed as a series of neural network layers or other algorithmic pipeline designed to handle images. For instance, the model can implement a U-Net architecture with self-attention layers at two bottom levels. This model can be trained using a large-scale video dataset to predict denoised outputs effectively. In one embodiment, the model can utilize a v-parameterization for both model output and loss, optimizing the network to handle specific types of image noise and artifacts. Example aspects of v-parameterization are described in Salimans and Ho. 2022. Progressive Distillation for Fast Sampling of Diffusion Models. In ICLR.

Denoised prediction i1\hat{ }1/4 308 can be an example of a partially refined image output produced at a one-quarter resolution level. Denoised prediction i1\hat{ }1/4 308 can be represented by a matrix of pixel intensities or by a compressed format. For instance, the denoised output can be further processed using a conditional diffusion process where the model uses patches from a bilinearly upsampled low-resolution intermediate and two input frames as conditioning. This can help in achieving a higher quality reconstruction by focusing on smaller regions and reducing computational overhead.

Input frame i0\hat{ }1/2 310 can be an example of image data downsampled to one-half of the original resolution. Input frame i0\hat{ }1/2 310 can be used as input to a process that operates at a mid-level scale. For instance, this frame can undergo similar preprocessing as the quarter-resolution frames, including noise reduction and downsampling. In one embodiment, this frame can be used in conjunction with a similar half-resolution frame from a subsequent time step to provide temporal information that aids in the prediction of intermediate frames.

Input frame i2\hat{ }1/2 312 can be another example of downsampled image data, also at one-half resolution. Input frame i2\hat{ }1/2 312 can be stored temporarily or persistently in a system memory. For instance, this frame can be part of a buffer that temporarily holds several frames for processing in a rolling window fashion, which can be beneficial for real-time video processing applications. In one embodiment, the stored frames can be accessed by the diffusion model in a sequence to maintain temporal coherence in the video data.

Model 316 can be an example of a diffusion model. Model 316 can be an example of a computational apparatus dedicated to handling image patches or frames. Model 316 can be implemented as a different set of parameters or architecture compared to model 306, or can be the same model.

Denoised prediction i1\hat{ }1/2 318 can be an example of a refined image produced at a half resolution level. Denoised prediction i1\hat{ }1/2 318 can be written to a file or transmitted across a network for further analysis. For instance, this image can be part of a larger video processing pipeline where it is combined with other similarly processed frames to reconstruct a high-resolution video sequence.

Input frame i0 320 can be an example of original resolution images. Input frame i0 320 can be captured by a camera or other acquisition device and preserved without further scaling. For instance, this frame can represent a high-resolution photograph or video frame that serves as a reference or ground truth in the image processing workflow.

Input frame i2 322 can be another example of full-resolution image data that follows or precedes Input frame i0 320 temporally or contextually. Input frame i2 322 can be manipulated by software to generate subsequent transformations. For instance, this frame can undergo various image enhancements such as color correction, sharpening, or dynamic range adjustment to improve its visual quality before being processed by the diffusion model. In one embodiment, the transformations applied to this frame can be optimized based on the specific requirements of the downstream processing steps, such as frame interpolation or noise reduction.

Model 326 can be a diffusion model. Model 326 can be implemented as a different set of parameters or architecture compared to models 306 and/or 316, or can be the same model. For instance, Model 326 can be the final stage in the cascade that processes full-resolution images to produce high-quality outputs.

Denoised prediction i1 328 can be an example of the output at the original resolution after the final-stage operation. Denoised prediction i1 328 can be stored, displayed, or otherwise utilized in an image-processing pipeline. For instance, this output can represent the final interpolated frame in a video sequence that has been enhanced to improve its frame rate or visual quality.

This frame can be displayed on a high-resolution monitor or incorporated into a multimedia presentation to provide a high-quality viewing experience. In one embodiment, the denoised prediction can also be analyzed using image quality assessment tools to quantitatively measure the improvements made by the diffusion process, providing feedback that can be used to further optimize the model.

### Example Devices and Systems

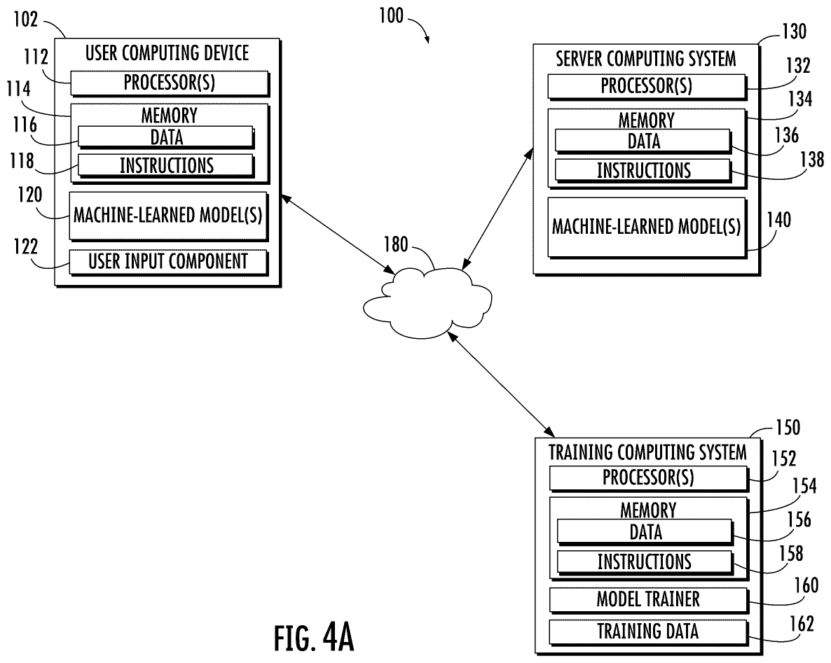

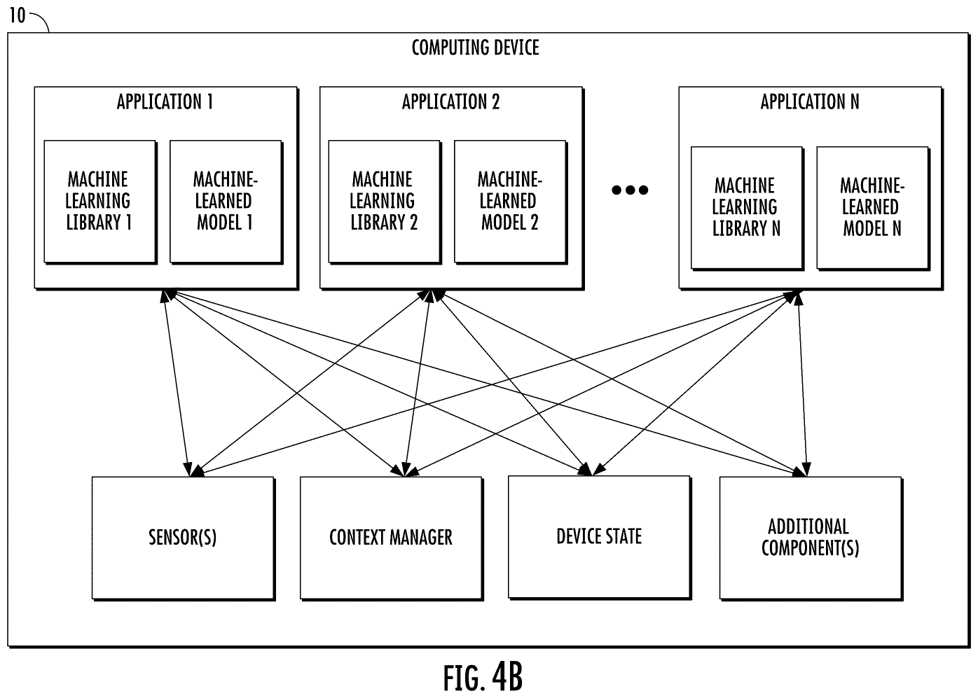

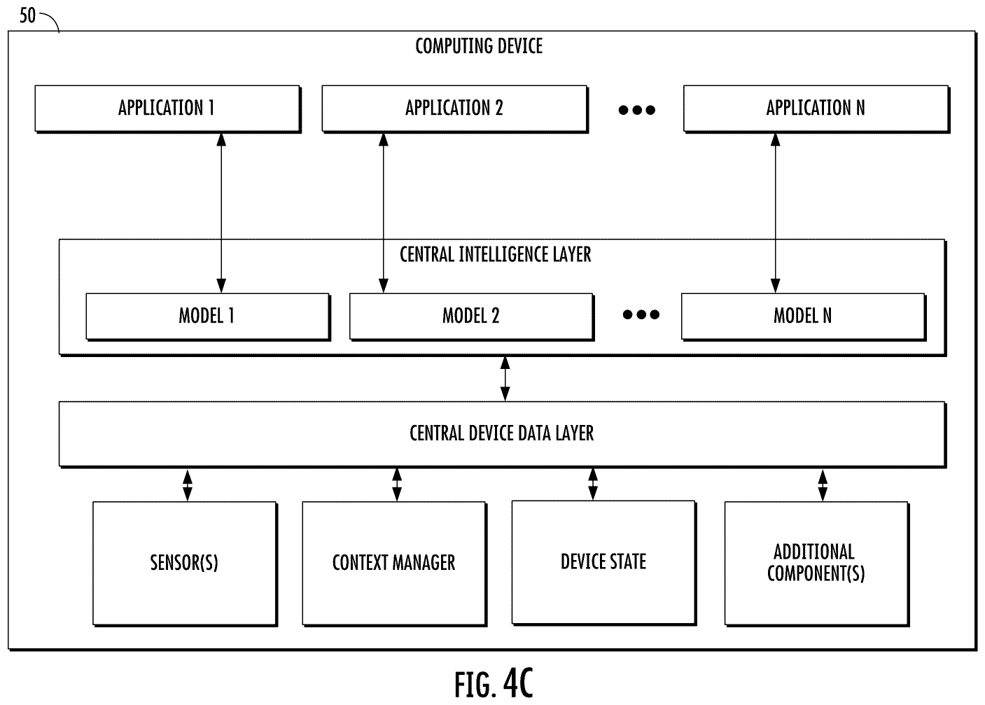

FIG. 4A depicts a block diagram of an example computing system 100 that performs image interpolation according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel image interpolation across multiple instances of input images).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an image interpolation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

One example type of machine learning model (e.g., model 120 and/or 140) is a denoising diffusion model (or “diffusion model”). A denoising diffusion model can be defined as a type of generative model that learns to progressively remove noise from a set of input data to generate new data samples. A comprehensive discussion of diffusion models is provided by Yang L., Zhang Z., Song Y., Hong S., Xu R., Zhao Y., Zhang W., Cui B., and Yang M., Diffusion Models: A Comprehensive Survey of Methods and Applications, arXiv:2209.00796 [cs.LG]. See also, Sohl-Dickstein, J., Weiss, E., Maheswaranathan, N., & Ganguli, S. (2015). Deep Unsupervised Learning using Nonequilibrium Thermodynamics. In International Conference on Machine Learning (ICML); Song, Y., & Ermon, S. (2019). Generative Modeling by Estimating Gradients of the Data Distribution. In Advances in Neural Information Processing Systems (NeurIPS); Ho, J., Jain, A., & Abbeel, P. (2020). Denoising Diffusion Probabilistic Models. In Advances in Neural Information Processing Systems (NeurIPS); and Song, Y., Sohl-Dickstein, J., Kingma, D. P., Kumar, A., Ermon, S., & Poole, B. (2020). Score-Based Generative Modeling through Stochastic Differential Equations. In International Conference on Learning Representations (ICLR).

More particularly, in some implementations, the diffusion process of a denoising diffusion model can include both forward and reverse diffusion phases. The forward diffusion phase can include gradually adding noise (e.g., Gaussian noise) to data over a series of time steps. This transformation can lead to the data eventually resembling pure noise. For example, in the context of image processing, an initially clear image can incrementally receive noise until it is indistinguishable from random noise. In some implementations, this step-by-step addition of noise can be parameterized by a variance schedule that controls the noise level at each step.

Conversely, the reverse diffusion phase can include systematically removing the noise added during the forward diffusion to reconstruct the original data sample or to generate new data samples. This phase can use a trained neural network model to predict the noise that was added (or conversely, that should be removed) at each step and subtract it from the noisy data. For instance, starting from a purely noisy image, the model can iteratively denoise the image, progressively restoring details until a clear image is obtained.

This process of reverse diffusion can be guided by learning from a set of training data, where the model learns the optimal way to remove noise and recover data. The ability to reverse the noise addition effectively allows the generation of new data samples that are similar to the training data and/or modified according to specified conditions. In particular, in the learned reverse diffusion process, the diffusion model can be used to generate new samples that can either replicate the original or produce variations based on the learned data distribution.

In some implementations, denoising diffusion models can operate in either pixel space or latent space, each offering distinct advantages depending on the application requirements. Operating in pixel space means that the model directly manipulates and generates data in its original form, such as raw pixel values for images. For example, when generating images, the diffusion process can add or remove noise directly at the pixel level, allowing the model to learn and reproduce fine-grained details that are visible in the pixel data.

Alternatively, operating in latent space can include transforming the data into a compressed, abstract representation before applying the diffusion process. This can be beneficial for handling high-dimensional data or for improving the computational efficiency of the model. For instance, an image can be encoded into a lower-dimensional latent representation using an encoder network, and the diffusion process can then be applied in this latent space. The denoised latent representation can subsequently be decoded back into pixel space to produce the final output image. This approach can reduce the computational load during the training and sampling phases and can sometimes help in capturing higher-level abstract features of the data that are not immediately apparent in the pixel space.

In some implementations, denoising diffusion models can utilize probability distributions to manage the transformation of data throughout the diffusion process. As one example, Gaussian distributions can be employed in the forward diffusion phase, where noise added to the data is typically modeled as Gaussian. This method can be beneficial for applications like image processing or audio synthesis, where the gradual addition of Gaussian noise helps in creating a smooth transition from original data to a noise-dominated state. However, the model can also be designed to use other types of noise distributions as part of its stochastic process.

In the reverse phase, learned transition distributions can guide the denoising steps. Specifically, a parameterized model (e.g., neural network) can be used to predict the noise to be removed at each step of the reverse phase.

Model parameters can refer to parameter values within the denoising diffusion model that can be learned from training data to optimize the performance of the denoising diffusion model. These parameters can include weights of the neural networks used to predict noise in the reverse diffusion process, as well as parameters defining the noise schedule in the forward process.

The architecture of an example denoising diffusion model can include one or more neural networks. The neural networks can be trained to parameterize the transition kernels in the reverse Markov chain. As examples, the architecture of a denoising diffusion model can incorporate various types of neural networks, such as Convolutional Neural Networks (CNNs) or Recurrent Neural Networks (RNNs).

As a specific example, in some implementations, the neural network architecture can take the form of a U-Net. The U-Net architecture is characterized by its U-shaped structure, which includes a contracting path and an expansive path. The contracting path follows the typical architecture of a convolutional network, including repeated application of convolutions, followed by pooling operations that reduce the spatial dimensions of the feature maps. The expansive path of the U-Net, on the other hand, can include a series of up-convolutions and concatenations with high-resolution features from the contracting path. This can be achieved through skip connections that directly connect corresponding layers in the contracting path to layers in the expansive path.

More generally, the neural network architecture in denoising diffusion models can include multiple layers that can include various types of activation functions. These functions introduce non-linearities that enable the network to capture and learn complex data patterns effectively, although the specific choices of layers and activations can vary based on the model design and application requirements.

Additionally, the architecture can include special components like residual blocks and attention mechanisms, which can enhance the model's performance. Residual blocks can help in training deeper networks by allowing gradients to flow through the network more effectively. Attention mechanisms can provide a means for the model to focus on specific parts of the input data, which is advantageous for applications such as language translation or detailed image synthesis, where contextual understanding significantly impacts the quality of the output. These components are configurable and can be integrated into the neural network architecture to address specific challenges posed by the complexity of the data and the requirements of the generative task.

In some implementations, the training process of a denoising diffusion model can be oriented towards specific learning objectives. These objectives can include minimizing the difference between the original data and the data reconstructed after the reverse diffusion process. Specifically, in some implementations, an objective can include minimizing the Kullback-Leibler divergence between the joint distributions of the forward and reverse Markov chains to ensure that the reverse process effectively reconstructs or generates data that closely matches the training data. As another example, in image processing applications, the objective may be to minimize the pixel-wise mean squared error between the original and reconstructed images. Additionally, the model can be trained to optimize the likelihood of the data given the model, which can enhance the model's ability to generate new samples that are indistinguishable from real data.

Various strategies can be used to perform the training process for diffusion models. Gradient descent algorithms, such as stochastic gradient descent (SGD) or Adam, can be utilized to update the model's parameters. Moreover, learning rate schedules can be implemented to adjust the learning rate during training, which can help in stabilizing the training process and improving convergence. For instance, a learning rate that decreases gradually as training progresses can lead to more stable and reliable model performance.

Various loss functions can be used guide the training of denoising diffusion models. Example loss functions include the mean squared error (MSE) for regression tasks or cross-entropy loss for classification tasks within the model. Additionally, variational lower bounds, such as the evidence lower bound (ELBO), can be used to train the model under a variational inference framework. These loss functions can help in quantifying the discrepancy between the generated samples and the real data, guiding the model to produce outputs that closely resemble the target distribution.

In some implementations, temperature sampling in denoising diffusion models can be used to control the randomness of the generation process. By adjusting the temperature parameter, one can modify the variance of the noise used in the sampling steps, which can affect the sharpness and diversity of the generated outputs. For instance, a lower temperature can result in less noisy and more precise samples, whereas a higher temperature can increase sample diversity but may also introduce more noise and reduce sample quality.

In some implementations, conditional generation can allow the generation of data samples based on specific conditions or attributes. Conditional generation in denoising diffusion models can include modifying the reverse diffusion process based on additional inputs (e.g., conditioning inputs) such as class labels or text descriptions, which guide the model to generate data samples that are more likely to meet specific conditions. This can be implemented by conditioning the model on additional inputs such as class labels, text descriptions, or other data modalities. For example, in a model trained on a dataset of images and their corresponding captions, the model can generate images that correspond to a given textual description, enabling targeted image synthesis.

More particularly, denoising diffusion models can be conditioned using various types of data to guide the generation process towards specific outcomes. One common type of conditioning data is text. For example, in generating images from descriptions, the model can use textual inputs like “a sunny beach” or “a snowy mountain” to generate corresponding images. The text can be processed using natural language processing techniques to transform it into a format that the model can utilize effectively during the generation process.

For example, one type of conditioning data can include text embeddings. Text embeddings are vector representations of text that capture semantic meanings, which can be derived from pre-trained language models such as BERT or CLIP. These embeddings can provide a denser and potentially more informative representation of text than raw text inputs. For instance, in a diffusion model tasked with generating music based on mood descriptions, embeddings of words like “joyful” or “melancholic” can guide the audio generation process to produce music that reflects these moods.

Additionally, conditioning can also include using categorical labels or tags. This approach can be particularly useful in scenarios where the data needs to conform to specific categories or classes.

Classifier-free guidance is a technique that can enhance the control over the sample generation process without the need for an additional classifier model. This can be achieved by modifying the guidance scale during the reverse diffusion process, which adjusts the influence of the learned conditional model. For instance, by increasing the guidance scale, the model can produce samples that more closely align with the specified conditions, improving the fidelity of generated samples that meet desired criteria without the computational overhead of training and integrating a separate classifier.

In some implementations, denoising diffusion models can integrate with other generative models to form hybrid models. For instance, combining a denoising diffusion model with a Generative Adversarial Network (GAN) can leverage the strengths of both models, where the diffusion model can ensure diversity and coverage of the data distribution, and the GAN can refine the sharpness and realism of the generated samples. Another example can include integration with Variational Autoencoders (VAEs) to improve the latent space representation and stability of the generation process.

Efficiency improvements are beneficial aspects of denoising diffusion models. One way to achieve this is by reducing the number of diffusion steps required to generate high-quality samples. For example, sophisticated training techniques such as curriculum learning can be employed to gradually train the model on easier tasks (fewer diffusion steps) and increase complexity (more steps) as the model's performance improves. Additionally, architectural optimizations such as implementing more efficient neural network layers or utilizing advanced activation functions can decrease computational load and improve processing speed during both training and generation phases.

Noise scheduling strategies can improve the performance of denoising diffusion models. By carefully designing the noise schedule—the variance of noise added at each diffusion step—models can achieve faster convergence and improved sample quality. For example, using a learned noise schedule, where the model itself optimizes the noise levels during training based on the data, can result in more efficient training and potentially better generation quality compared to fixed, predetermined noise schedules.

In some implementations, learned upsampling in denoising diffusion models can facilitate the generation of high-resolution outputs from lower-resolution inputs. This technique can be particularly useful in applications such as high-definition image generation or detailed audio synthesis. Learned upsampling can include additional model components that are trained to increase the resolution of generated samples through the reverse diffusion process, effectively enhancing the detail and quality of outputs without the need for externally provided high-resolution training data. In some cases, these additional learned components can be referred to as “super-resolution” models.

In some implementations, denoising diffusion models can be applied to the field of image synthesis, where they can generate high-quality, photorealistic images from a distribution of training data. For example, example models can be used to create new images of landscapes, animals, or even fictional characters by learning from a dataset composed of similar images. The model can add noise to these images and then learn to reverse this process, effectively enabling the generation of new, unique images that maintain the characteristics of the original dataset.

Denoising diffusion models can also be utilized in audio generation. They can generate clear and coherent audio clips from noisy initial data or even from scratch. For instance, in the music industry, example models can help in creating new musical compositions by learning from various genres and styles. Similarly, in speech synthesis, denoising diffusion models can generate human-like speech from text inputs, which can be particularly beneficial for virtual assistants and other AI-driven communication tools.

Other potential use cases of denoising diffusion models extend across various fields including drug discovery, where example models can help in generating molecular structures that could lead to new pharmaceuticals. Additionally, in the field of autonomous vehicles, denoising diffusion models can be used to enhance the processing of sensor data, improving the vehicle's ability to interpret and react to its environment.

In some implementations, the performance of denoising diffusion models can be evaluated using various metrics that assess the quality and diversity of generated samples. The Inception Score (IS) is one such metric that can be used; it measures how distinguishable the generated classes are and the confidence of the classification. For example, a higher Inception Score indicates that the generated images are both diverse across classes and each image is distinctly recognized by a classifier as belonging to a specific class. Another commonly used metric is the Fréchet Inception Distance (FID), which assesses the similarity between the distribution of generated samples and real samples, based on features extracted by an Inception network. A lower FID indicates that the generated samples are more similar to the real samples, suggesting higher quality of the generated data.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, triplets that include pairs of inputs images and a target interpolated image.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method of high-resolution frame interpolation with patch-based cascaded diffusion, the method comprising:
obtaining, by a computing system comprising one or more computing devices, a first input frame associated with a first time and a second input frame associated with a second time that is subsequent to the first time, wherein the first input frame and the second input frame have an input resolution;
recursively for each of one or more patch-based frame interpolation stages:
generating, by the computing system, a plurality of groups of patches, wherein each group of patches comprises a respective patch from each of: a current version of the first input frame, a current version of the second input frame, and an input version of a predicted intermediate frame associated with an intermediate time that is temporally between the first time and the second time, and wherein each patch has a second resolution that is smaller than the input resolution; and
respectively processing, by the computing system, the plurality of groups of patches and a respective noisy input with a machine-learned diffusion model to generate a respective predicted patch for a denoised version of the predicted intermediate frame; and
accumulating, by the computing system, the respective predicted patches to generate the denoised version of the predicted intermediate frame.

2. The computer-implemented method of claim 1, wherein the one or more patch-based frame interpolation stages comprise a plurality of patch-based frame interpolation stages.

3. The computer-implemented method of claim 2, wherein, for each of the plurality of patch-based frame interpolation stages, the patches have a consistent resolution and the same machine-learned diffusion model is used.

4. The computer-implemented method of claim 2, wherein, for each of the plurality of patch-based frame interpolation stages except a final stage, the method further comprises upsampling the denoised version of the predicted intermediate frame to generate the input version of the predicted intermediate frame for a next stage.

5. The computer-implemented method of claim 2, wherein, for each of the plurality of patch-based frame interpolation stages, the current version of the first input frame and the current version of the second input frame have been downsampled to a current resolution respectively associated with the stage.

6. The computer-implemented method of claim 2, wherein, for a final stage of the plurality of patch-based frame interpolation stages, the method further comprises outputting, by the computing system, the denoised version of the predicted intermediate frame as an output.

7. The computer-implemented method of claim 1, further comprising, prior to the one or more patch-based frame interpolation stages:
respectively downsampling, by the computing system, the first input frame and the second input frame to respectively generate a first downsampled input frame and a second downsampled input frame, wherein the first downsampled input frame and the second downsampled input frame have the second resolution; and
processing, by the computing system, a noisy input with a machine-learned denoising diffusion model that is conditioned on the first downsampled input frame and the second downsampled input frame to generate an initial version of the predicted intermediate frame, wherein the initial version of the predicted intermediate frame has the second resolution.

8. The computer-implemented method of claim 1, further comprising, prior to the one or more patch-based frame interpolation stages constructing an N-level image pyramid from the first input frame and the second input frame.

9. The computer-implemented method of claim 1, wherein the groups of patches comprise groups of overlapping patches.

10. The computer-implemented method of claim 1, wherein the machine-learned diffusion model comprises a pixel diffusion model.

11. A computing system configured to train a denoising diffusion model, the computing system comprising one or more computing devices and configured to perform operations, the operations comprising:
obtaining, by a computing system comprising one or more computing devices, a first input frame associated with a first time, a second input frame associated with a second time that is subsequent to the first time, and a target version of an intermediate frame that is associated with an intermediate time that is temporally between the first time and the second time;
generating, by the computing system, a noisy version of the intermediate frame;
generating, by the computing system, a plurality of groups of patches, wherein each group of patches comprises a respective patch from each of: first input frame, the second input frame, and the noisy version of the intermediate frame;
respectively processing, by the computing system, the plurality of groups of patches and a respective noisy input with the denoising diffusion model to generate a respective predicted patch for a denoised version of the intermediate frame; and
modifying, by the computing system, one or more values of one or more parameters of the denoising diffusion model based on a loss function that compares the denoised version of the intermediate frame with the target version of the intermediate frame.

12. The computing system of claim 11, wherein generating, by the computing system, the noisy version of the intermediate frame comprises:
generating, by the computing system, a lower resolution version of the intermediate frame; and
upsampling, by the computing system, the lower resolution version of the intermediate frame to obtain the noisy version of the intermediate frame.

13. The computing system of claim 12, wherein generating, by the computing system, the lower resolution version of the intermediate frame comprises:
respectively downsampling, by the computing system, the first input frame and the second input frame to respectively generate a first downsampled input frame and a second downsampled input frame; and
processing, by the computing system, the first downsampled input frame and the second downsampled input frame with a base diffusion model to generate the lower resolution version of the intermediate frame.

14. A computing system to perform image interpolation with improved computational efficiency, the computing system comprising:
one or more processors; and
one or more non-transitory computer-readable media that collectively store instructions that, when executed by the one or more processors, cause the computing system to perform operations, the operations comprising:
obtaining a first input image associated with a first time and a second input image associated with a second time that is subsequent to the first time, wherein the first input image and the second input image have a first image resolution;
downsampling the first input image and the second input image to generate a first downsampled input image and a second downsampled input image, wherein the first downsampled input image and the second downsampled input image have a second image resolution that is less than the first image resolution;
processing the first downsampled input image, the second downsampled input image, and a first noisy input with a recursively-cascading machine-learned denoising diffusion model to generate a first predicted image, wherein the first predicted image is associated with a third time that is temporally between the first time and the second time, and wherein the first predicted image has the second image resolution;
upsampling the first predicted image to generate a first upsampled predicted image that has the first resolution; and
processing at least the first upsampled predicted image and a second noisy input with the recursively-cascading machine-learned denoising diffusion model to generate a second predicted image, wherein the second predicted image is associated with the third time that is temporally between the first time and the second time, and wherein the second predicted image has the first image resolution.

15. The computing system of claim 14, wherein the recursively-cascading machine-learned denoising diffusion model has been trained on one or more image quadruplets, each image quadruplet comprising a first training image, a second training image, a target intermediate image, and a first upsampled predicted training image, the first upsampled predicted training image being an upsampled version of a first predicted training image predicted at a lower resolution.

16. The computing system of claim 15, wherein, during the training of the recursively-cascading machine-learned denoising diffusion model, dropout was performed on the first upsampled predicted training image.

17. The computing system of claim 14, wherein the recursively-cascading machine-learned denoising diffusion model performs eight or fewer denoising steps.

18. The computing system of claim 14, wherein the recursively-cascading machine-learned denoising diffusion model performs four or fewer denoising steps.

19. The computing system claim 14, wherein processing at least the first upsampled predicted image and the second noisy input with the recursively-cascading machine-learned denoising diffusion model to generate the second predicted image comprises processing the first upsampled predicted image, the first input image, the second input image, and the second noisy input with the recursively-cascading machine-learned denoising diffusion model to generate the second predicted image.

20. One or more non-transitory computer-readable media that collectively store instructions that, when executed by a computing system, cause the computing system to perform operations, the operations comprising:
for each of a plurality of recursions respectively associated with a plurality of different image scales:
obtaining a pair of input images associated with the image scale;
upsampling a smaller-resolution predicted image generated by a recursively-cascading machine-learned denoising diffusion model for a smaller image scale to obtain an upsampled version of the smaller-resolution predicted image; and
processing the pair of input images, the upsampled predicted image, and a noisy input with the recursively-cascading machine-learned denoising diffusion model to generate a predicted image for the image scale.
